(19) United States
(12) Patent Application Publication
(10) Pub. No.: US 2024/0346484 A1
(43) Pub. Date: Oct. 17, 2024

(54) COMPUTERIZED SYSTEM AND METHOD FOR PROVIDING AN ACTIVITY BASED, INTERACTIVE CRYPTOCURRENCY AND NFT MARKETPLACE

(71) Applicant: Hole-In-One Media, Inc., Austin, TX (US)

(72) Inventor: Kevin R. Imes, Austin, TX (US)

(21) Appl. No.: 18/633,340

(22) Filed: Apr. 11, 2024

Related U.S. Application Data
(60) Provisional application No. 63/459,005, filed on Apr. 13, 2023.

(51) Int. Cl. G06Q 20/36; A63B 24/00; A63B 71/06; A63B 102/32

(52) U.S. Cl. CPC G06Q 20/367; A63B 24/0006; A63B 24/0059; A63B 24/0084; A63B 71/0616; A63B 2024/0068; A63B 2102/32; A63B 2220/05; A63B 2220/806

(57) ABSTRACT

The disclosed systems and methods provide a novel framework for an activity based interactive cryptocurrency and non-fungible token (NFT) marketplace. The disclosed framework provides a computational environment where a user's real-world and/or digital activity can cause the user to be provided with a quantity and/or a value of cryptocurrency, as well as granted exclusive rights to an NFT that captures their real-world activity. The disclosed systems and methods can utilize on-site video recording capabilities that enables users to have their activities recorded (or captured) for the purposes of determining whether they are to be rewarded with a digital asset(s). In some embodiments, users can be granted specifically created and allocated cryptocurrency for playing a venue and/or winning a completion at a venue; and in some embodiments, users can obtain a NFT associated with their on-site activity/recording.

### CROSS-REFERENCE TO RELATED APPLICATION

This utility application claims the benefit of U.S. Provisional Application No. 63/459,005 filed Apr. 13, 2023. The entire disclosure of the above application is incorporated herein by reference.

### FIELD

The present disclosure relates generally to providing a cryptocurrency and non-fungible token (NFT) marketplace, and more particularly, to a computerized framework for hosting, generating and managing how proprietary cryptocurrency coins and NFTs are allocated to users in accordance with real-world and/or digital user activities that correlate to delineated smart-contracted performances.

### BACKGROUND

Currently, there are a variety of different platforms and applications that enable the purchase and allocation of digital assets, such as, for example, cryptocurrency (referred to as crypto, cryptocurrencies and/or coins, interchangeably), tokens and NFTs. For example, a variety of established cryptocurrencies can be purchased by users on cryptocurrency exchanges (e.g., Coinbase®); and artist generated NFTs can be purchased from NFT marketplaces (e.g., SuperRare™).

### SUMMARY

However, conventional mechanisms for the purchase and/or allocation of these digital assets are strictly tied to environments that include electronic gaming, trading, auctions, and the like. That is, there is currently no existing mechanism where a user's activity can trigger the acquirement of cryptocurrency and/or a NFT. As discussed herein, in some embodiments, the disclosed framework provides a novel computational environment where a user's real-world activity can cause the user to be provided with a quantity and/or a value of cryptocurrency, as well as granted exclusive rights to an NFT that captures their real-world activity.

For purposes of this disclosure, the discussion herein will focus on a real-world activity, for example, golfing; however, it should not be construed as limiting, as any other type of real-world and digital (e.g., augmented reality (AR), virtual reality (VR), gaming and/or metaverse) activity can be utilized without departing from the scope of the instant disclosure.

According to some embodiments, the disclosed systems and methods can utilize on-site video recording capabilities that enables users (or players, used interchangeably) to have their activities recorded (or captured) for the purposes of determining whether they are to be rewarded with a digital asset(s) (e.g., cryptocurrency tied to playing a venue, cryptocurrency tied to a contest at the venue and/or a NFT associated with on-site video).

In some embodiments, the on-site video recordings can correspond to the computational video analysis disclosed in commonly owned applications: U.S. patent application Ser. No. 17/680,506, entitled “Autonomous Activity Monitoring System and Method,” filed Feb. 25, 2002; and U.S. patent application Ser. No. 17/680,788, entitled “Artificial Intelligence-Enabled Golf Course,” filed Feb. 25, 2022, which are both incorporated in their entirety by reference.

By way of a non-limiting example, according to some embodiments, when a user registers a tee-time with a specific golf course, the framework can allocate a value of a specific cryptocurrency for that user. In some embodiments, the cryptocurrency can be any type of known or to be known type/form of cryptocurrency, stablecoin, digital currency (e.g., token), and the like.

In some embodiments, the cryptocurrency can be specific to, but is not limited to, the identity of the course, type of course, prestige of the course, cost (e.g., in fiats) to play the course (e.g., greens fees), the framework, a time period, a geographical region, an event, the user's handicap, frequency the user has played the course, how many players in the user's grouping, whether the user is walking or riding a cart, whether the user is a member of the course or an affiliated group (e.g., ClubCorp®), types of equipment the user is using (e.g., clubs, balls, shoes, and the like), types of apparel the user is wearing (e.g., which brand), the weather, and the like, or some combination thereof.

Continuing with the above example, the disclosed framework can also enable opportunities of the user to obtain additional cryptocurrency from his/her activities on the course. For example, if the course is hosting a “closest to the pin” competition, the course can have cameras situated along a specific par-3 hole(s), which can be enabled via, but not limited to, drones, mobile phone cameras, stationary cameras, staff with cameras, cameras on golf carts, and the like. A set of cameras (e.g., 3, for example) can be positioned at each specific location along a hole, which can include, but is not limited to, the tee box, along the fairway, on the green and/or in and/or around any hazard along the hole (e.g., trees, fescue, bunker, water, and the like).

Thus, as discussed below in more detail, the framework can automatically analyze and determine which user's shot was closest to the pin, and thereby identify them as the winner. As discussed in more detail below, the winner can be automatically allocated a specifically delineated form and/or quantity of cryptocurrency (e.g., directly deposited into his/her digital wallet, for example).

In some embodiments, when a user plays the specifically designated holes associated with the competition, his/her swings/shots can be recorded, whereby the framework can automatically determine shot characteristics for the user's tee-shot. In some embodiments, the shot characteristics can include, but are not limited to, swing speed, trajectory, ball speed, loft, launch angle, impact angle, carry, where it landed, roll, and the like, or some combination thereof.

As such, according to some embodiments, additional and/or alternative competitions can be held according to a criteria, whereby shot characteristics for a user can dictate whether they are declared a “winner” of specific competitions. For example, a criteria can correspond to a user's shot characteristics for a particular hole, set of holes, aggregate over 18 holes or average over 18 holes, and the like, or some combination thereof. Thus, for example, if a user registers the fastest swing speed on a hole, and his drive lands in the fairway, then he can be deemed a winner of a “swing speed” competition for a specific hole, or the competition altogether. As discussed herein, this can involve an allocation of a specific cryptocurrency to the winner's digital wallet.

According to some embodiments, as discussed in more detail below, video recordings of the user's play (e.g., swings, putts, chips, and the like) can be automatically saved and stored in an associated database of the disclosed framework. These video records can be stored as NFTs, and made available for the user. In some embodiments, as discussed below, the NFTs can be hosted for sale on a marketplace (e.g., an NFT marketplace proprietary to the course and/or framework, and/or a third party marketplace), directly sent to a user upon the user being determined a winner of a competition, hosted and/or provided to the course (e.g., on the course's website or social media feed, for example), and the like, or some combination thereof. Thus, a user, the hosting course and/or other users can avail themselves to NFTs of golf swings registered by the user on a course.

For example, if a user is playing the 17^{th} hole at TPC Sawgrass® for the first time, they can have the capability of purchasing an NFT of their tee-shot on that hole.

In another non-limiting example, during the American Century Celebrity Golf Championship, a celebrity makes a hole in one on a golf hole. Users attending the event, having been allocated coins for that specific event at the South Lake Tahoe course, can use their coins to bid on and purchase an NFT of that celebrity's shot. In some embodiments, only coins specific to that event can be used to purchase the NFT created from that specific event.

According to some embodiments, the disclosed framework is configured to utilize cryptocurrencies in several ways, as discussed herein. In some embodiments, the framework can execute an initial coin offering (ICO). The ICO can be tied to a set of users, entities, courses, time periods, geographic regions, seasons, tournaments (e.g., FedEx® Cup playoffs on the PGA® tour, for example), and the like. In some embodiments, the ICO can involve a cryptocurrency and/or stablecoin (e.g., a coin backed by a fiat), whereby a particular amount of initial coins are made available for allocation.

As mentioned above, and discussed below, the ICO can be tied to user participation in competitions at courses, and/or actually playing specific courses; therefore, in order for users to obtain coins, the user must actively participate in playing golf to obtain coins (rather than purchasing coins as with traditional ICOs). In some embodiments, courses can be allocated a certain number of coins, which as mentioned above and discussed in more detail below, can be tied to notoriety of the course, popularity of the course, greens fees of the course, and the like. For example, a local municipal course in Austin, TX may only be granted 1,000 coins; whereas Pebble Beach Golf Course in CA may be allocated IM coins. However, if the local municipal course is a staple of the community, for example Lyons Golf Course in Austin, then it may have more coins allocated—for example, 100,000. Moreover, as mentioned above, each course can have its own special coin (e.g., cryptocurrency) that can only be collected from that specific course.

According to some embodiments, instead of having just one coin for the framework, the disclosed systems and methods can create, host and allocate coins for every golf course, and manage their coins in a single platform. By way of a non-limiting example, a total number of coins can be pooled for a course, using 10M as an example: 1) 1M can be owned by the golf course; 2) 1M can be sold as part of an ICO; 3) 1M can be sold to a third party sponsor; 4) 2M can be retained by the entity operating the framework. That leaves 5M coins to be distributed to players as they play that course.

According to some embodiments, the disclosed framework can enable sponsorship (or sponsor) coins, which can be issued based on a sale of a sponsor opportunity to an investor that wants to share in the revenue (e.g., daily revenue for the framework). For example, the rights for $200K can be sold to a sponsor entity (e.g., Titleist®), and the sponsor could get a predetermined share (e.g. 10-20% cut) of the daily revenue of coin allocations and purchases on/at courses via those coins (or associated fiats).

According to some embodiments, the framework can have a consolidated class of coins. This can be per region, type of course (e.g., links, parkland, heathland, and the like; or public, private, and the like), season, and the like, or some combination thereof. For example, courses can be set up in the following way: Private Clubs, Semi-Private Clubs, Public, Resorts and Municipals. As courses are brought online via the framework's functionality (e.g., specific tokens for each course type), they would fall into one of those categories. In some embodiments, for the higher-end courses such as, for example, St. Andrews Links, allocated coins can be specifically created and/or branded.

According to some embodiments, the framework can operate by monetizing the sale of each coin based on an applied fee for every coin exchange. In some embodiments, fees can be inversely proportional to the volume of coins. For example, low fees can be applied because volumes are large.

By way of a non-limiting example, according to some embodiments of the instant disclosure, having 10 courses each having 100M coins in the market results in 1B coins in the market. A $0.01 fee every time it is traded will result in large amounts of passive income to the company operating the framework. Daily volumes can average 100M trades a day, which would result in $1M in trade fees daily. In some embodiments, fees can also be applied based on the ICO of each coin. For example, retaining a predetermined percentage (e.g., 20%) of the actual coin that was issued, which can be bought and sold upon allocation/issuance to a user.

According to some embodiments, the present disclosure provides computerized methods for a novel framework for an activity based interactive cryptocurrency and NFT marketplace.

According to some embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, content server, ad server and/or client device, and the like) cause at least one processor to perform a method for a novel and improved framework for an activity based interactive cryptocurrency and NFT marketplace.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with embodiments of the present disclosure;

FIG. 4 is a block diagram illustrating an exemplary data flow in accordance with some embodiments of the present disclosure;

FIG. 5 is a block diagram illustrating an exemplary data flow in accordance with some embodiments of the present disclosure;

FIG. 6 is a block diagram illustrating an exemplary data flow in accordance with some embodiments of the present disclosure; and

FIG. 7 is a block diagram illustrating an exemplary data flow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers, such as Amazon Web Services (AWS) servers, are non-limiting examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

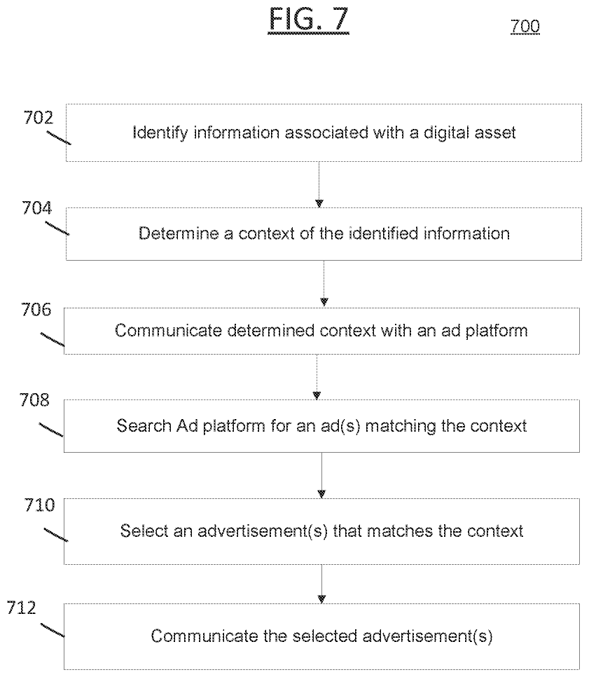

As discussed in more detail below at least in relation to FIG. 7, according to some embodiments, information associated with, derived from, or otherwise identified from, during or as a result of a generation, allocation, purchase, trading, sharing, rendering and/or display of cryptocurrency and/or NFT, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

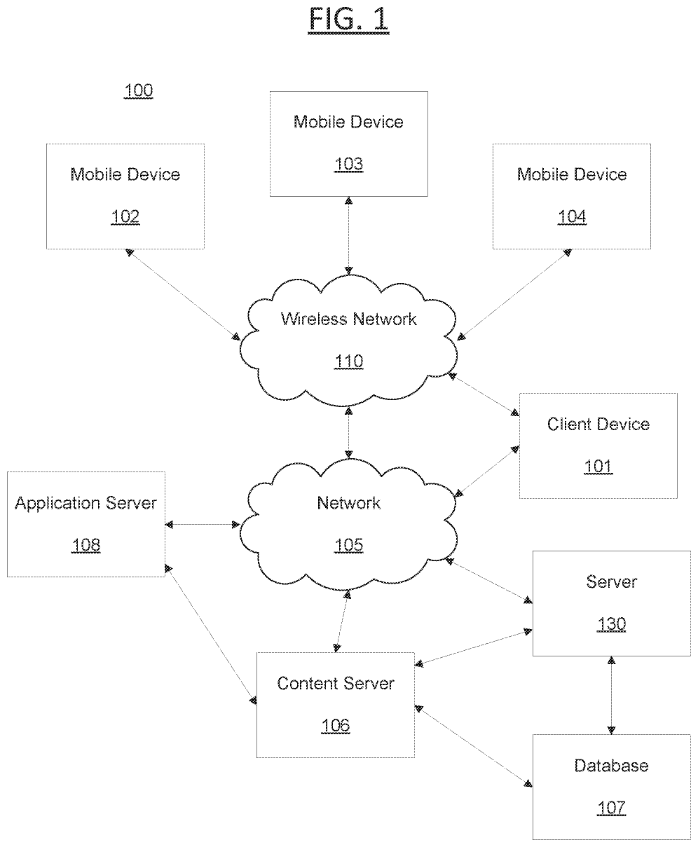

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108 and third party server 130.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like.

According to some embodiments, content server 106 can be configured to provide services, applications and/or content related to, but not limited to, capturing, streaming and/or downloading media services (e.g., recording and storing videos, for example). According to some embodiments, content server 106 can further provide a variety of services that include, but are not limited to, email services, instant messaging (IM) services, search services, photo services, web services, social networking services, news services, third-party services, audio services, video services, SMS services, MMS services, FTP services, voice over IP (VOIP) services, or the like.

Third party server 130 can comprise a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user data. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is, advertisers will pay higher advertising rates when they believe their ads are being placed in or along with highly relevant content that is being presented to users. Reductions in the time needed to quantify a high quality ad placement offers ad platforms competitive advantages. Thus, higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en-masse to advertisers. For web portals, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, gender, occupation, and the like) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. In some embodiments, profiles can be created based on a QR code, as discussed below, which can be correlated an event, course, type of course, type of activity, location (e.g., a geo-fenced area such as a golf course or hole(s) on a golf course), time period, and the like, or some combination thereof. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In some embodiments, users are able to access services provided by servers 106, 108 and/or 130. This may include in a non-limiting example, streaming media servers, recording servers, authentication servers, search servers, email servers, social networking services servers, SMS servers, IM servers, MMS servers, exchange servers, photo-sharing services servers, travel services servers, and the like, via the network 105 using their various devices 101-104.

In some embodiments, applications, such as streaming media applications (e.g., Spotify®, Netflix®, Apple Music®, and the like), mail applications (e.g., Gmail®, and the like), instant messaging applications, blog, photo or social networking applications (e.g., Facebook®, Twitter®, Instagram®, and the like), search applications (e.g., Google® Search), news applications (e.g., Huffington Post®, CNN®, and the like) and the like, can be hosted by the application server 108 or content server 106, and the like. In some embodiments, application server 108 (or content server 106) can host applications for playing specific activities (e.g., playing golf and/or booking tee-times) and/or applications associated with specific courses, and/or the disclosed framework, as discussed herein.

Thus, the application server 108, for example, can store various types of applications and application related information including application data and user profile information (e.g., identifying and behavioral information associated with a user, as well as data related to hosted media (e.g., audio files, for example)). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108 and/or 130.

Moreover, although FIG. 1 illustrates servers 106, 108 and 130 as single computing devices, respectively, the disclosure is not so limited. For example, one or more functions of servers 106, 108 and/or 130 may be distributed across one or more distinct computing devices. Moreover, in one embodiment, servers 106, 108 and/or 130 may be integrated into a single computing device, without departing from the scope of the present disclosure.

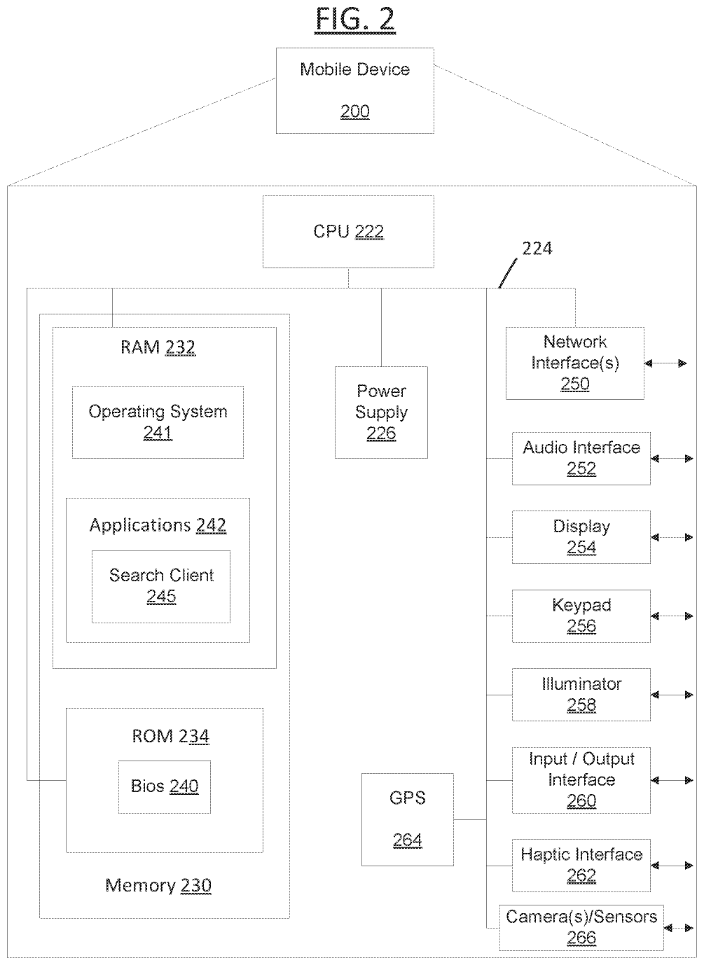

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to Client device 200.

Client device 200 may optionally communicate with a base station (not shown), or directly with another computing device. Network interface 250 is sometimes known as a transceiver, transceiving device, or network interface card (NIC).

Audio interface 252 is arranged to produce and receive audio signals such as the sound of a human voice. Display 254 may be a liquid crystal display (LCD), gas plasma, light emitting diode (LED), organic light-emitting diode (OLED), or any other type of display used with a computing device. Display 254 may also include a touch sensitive screen arranged to receive input from an object such as a stylus or a digit from a human hand.

Keypad 256 may comprise any input device arranged to receive input from a user. Illuminator 258 may provide a status indication and/or provide light.

Client device 200 also comprises input/output interface 260 for communicating with external. Input/output interface 260 can utilize one or more communication technologies, such as USB, infrared, Bluetooth™M, or the like. Haptic interface 262 is arranged to provide tactile feedback to a user of the client device.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. In one embodiment, however, Client device may through other components, provide other information that may be employed to determine a physical location of the device, including for example, a MAC address, Internet Protocol (IP) address, or the like.

Mass memory 230 includes a RAM 232, a ROM 234, and other storage means (e.g., EEPROM, for example). Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200.

Memory 230 further includes one or more data stores, which can be utilized by Client device 200 to store, among other things, applications 242 and/or other information or data. For example, data stores may be employed to store information that describes various capabilities of Client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 200.

Applications 242 may include computer executable instructions which, when executed by Client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

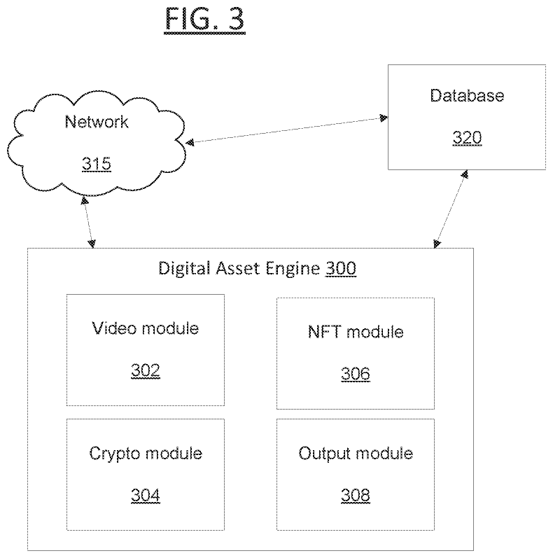

FIG. 3 is a block diagram illustrating the components for performing the systems and methods discussed herein. FIG. 3 includes digital asset engine 300, network 315 and database 320. The digital asset engine 300 can be a special purpose machine or processor and could be hosted by a cloud server (e.g., cloud web services server(s)), application server, content server, social networking server, web server, search server, content provider, third party server, user's computing device, and the like, or any combination thereof.

According to some embodiments, digital asset engine 300 can be embodied as a stand-alone application that executes on a user device. In some embodiments, the digital asset engine 300 can function as an application installed on the user's device, and in some embodiments, such application can be a web-based application accessed by the user device over a network. In some embodiments, the digital asset engine 300 can be installed as an augmenting script, program or application (e.g., a plug-in or extension) to another application or portal data structure.

The database 320 can be any type of database or memory, and can be associated with a content server on a network (e.g., content server or application server) or a user's device (e.g., device 101-104 or device 200 from FIGS. 1-2). Database 320 comprises a dataset of data and metadata associated with local and/or network information related to users, services, applications, content and the like.

In some embodiments, such information can be stored and indexed in the database 320 independently and/or as a linked or associated dataset. A non-limiting example of this is look-up table (LUT) or a blockchain. As discussed above, it should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user patterns, user attributes, user preferences or settings, user demographic information, user location information, user biographic information, and the like, or some combination thereof.

In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with users, golf courses, golf clubs, golf statistics, images, videos, audio, text, products, items and services from an assortment of media, applications and/or service providers and/or platforms, and the like. Accordingly, any other type of known or to be known attribute or feature associated with a user, golf equipment, golf course, cryptocurrency, smart contract, exchange, marketplace, data item, login, logout, website, application, communication (e.g., a message) and/or its transmission over a network, content included therein, or some combination thereof, can be saved as part of the data/metadata in datastore 320.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the digital asset engine 300, and the database of stored resources 320. Indeed, as illustrated in FIG. 3, the digital asset engine 300 and database 320 can be directly connected by any known or to be known method of connecting and/or enabling communication between such devices and resources.

The principal processor, server, or combination of devices that comprise hardware programmed in accordance with the special purpose functions herein is referred to for convenience as digital asset engine 300, and includes video module 302, crypto module 304, NFT module 306 and output module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

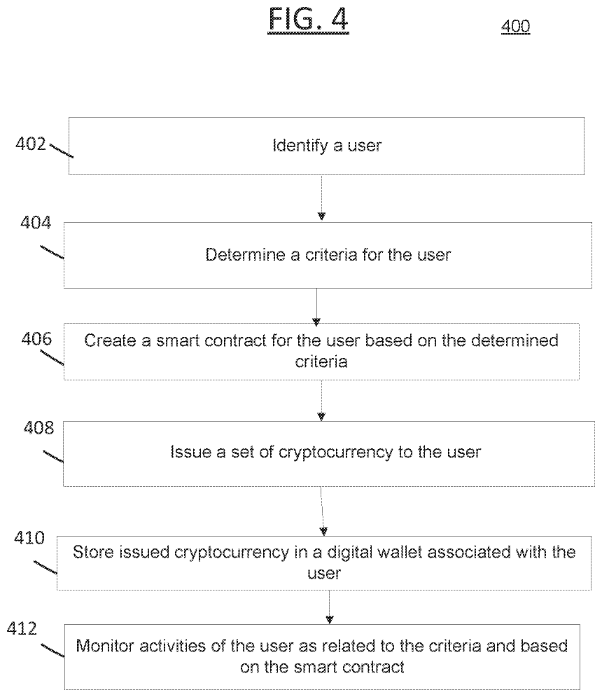

Turning to FIG. 4, Process 400 details non-limiting embodiments for establishing a smart contract for a user as the user registers to play a golf course. For example, upon the user registering their tee-time and going out on the course, the disclosed framework (e.g., via engine 300) can create a smart contract that can govern how the user can obtain cryptocurrencies from their play, as well as procure NFTs of their recorded shots on the course.

According to some embodiments, Steps 402-410 of Process 400 can be performed crypto module 304 of digital asset engine 300; and Step 412 can be performed by video module 302.

Process 400 begins with Step 402 where engine 300 identifies a user. According to some embodiments, the identification of the user can be based on, but not limited to, signing up for a tee-time, paying greens fees, being determined (e.g., via GPS) that they are on the course, that they are at a specific hole (e.g., 1^{st} tee), the scanning of a QR code (which can be a QR code for a course and/or a hole(s) at the course), being at the range, and the like, or some combination thereof.

For example, Step 402 can involve the user paying for the greens fees for a course (e.g., and the time associated with the greens fees (e.g., their tee-time) being proximate to a current time—the user tees off in 5 minutes).

In another non-limiting embodiment, Step 402 can involve a user scanning a QR code at the 1st tee of a golf course via their mobile device, which can trigger a thin client executing on the user's device to communicate with a cloud sever (e.g., AWS server) to monitor the user's session, as discussed herein. In some embodiments, the QR code scan can request validation of the user's identity, which can involve the identification of the user's phone number, a PIN entry, a biometric scan, and the like, or some combination thereof. For example, upon a QR scan, a web page can be presented on the user's device of the entry of their phone number. In some embodiments, 2-factor identification can be required based on the users' phone number entry. Thus, according to some embodiments, upon the scanning of a QR code, a profile for the user can be created, or identified and updated (should one already exist for the user).

In some embodiments, engine 300 can execute any type of known or to be known QR code generator solution, application and/or platform, such as, but not limited to, Beaconstac. According to some embodiments, triggering and activation of the QR code via the user's device enables the tracking of the user's play (or involvement in a competition), and ultimate reception of a created NFT and/or payout, as discussed below in more detail.

In yet another non-limiting embodiment, engine 300 can execute artificial intelligence (AI) software or program that can detect that a particular user is “on the tee”—for example, an AI program that can detect, determine or otherwise identify a user's color scheme in order to identify that particular user, which can be utilized to track the user on that specific hole and/or as the user plays other shots on that hole and other holes on the golf course. It should be understood that other types of known or to be known AI programs can be utilized to identify and track a user, such as, but not limited to, computer vision, facial recognition, and the like, or some combination thereof.

As mentioned above, and discussed below in more detail, each course can have a specifically delineated cryptocurrency, which can be automatically allocated to the user for playing the course.

In Step 404, engine 300 determines a criteria for the user. According to some embodiments, the criteria can relate to, but is not limited to, the user's identity, the user's handicap, type of equipment the user is using, activities on the course (e.g., long drive competition, shot characteristics competition, closest to the pin, shotguns, scrambles, skins, stroke-play, and the like, or some combination thereof), characteristics of the course (e.g., course length, par value for the course, course type, weather conditions, and the like), and the like, or some combination thereof.

Thus, in Step 404, for example, engine 300 can determine that there is a closest to the pin competition on the first par-3 hole (e.g., hole 3, for example), and based on the user's skill level (e.g., which tee-box they are playing from), he/she will be granted a predetermined number (e.g., 10 coins) should he/she be at least a top n (e.g., top 3) in the competition.

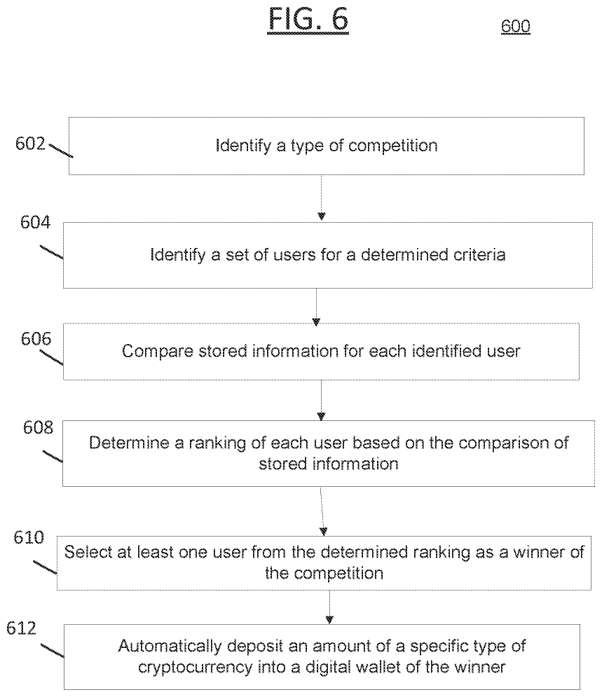

In Step 406, engine 300 creates and stores a smart contract for the user that includes information related to the determined criteria. As understood by those of skill in the art, smart contracts are programs stored on a blockchain that run when predetermined conditions are met. Here, the predetermined conditions correlate to the determined criteria (from Step 404). Smart contracts, therefore, are used to automate the execution of an agreement so that all participants can be immediately certain of the outcome, without any intermediary's involvement or time-loss. Thus, as discussed above and in more detail below (e.g., as least in relation to FIG. 6), upon the user winning the competition (or placing within the top 3), the 10 coins can be automatically deposited into his/her digital wallet.

In Step 408, engine 300 issues a set of cryptocurrency to the user. The issuance of the cryptocurrency for deposit into the digital wallet of the user can directly correspond to the user playing the course, where the value and/or quantity of coins is attributed to that specific course. As mentioned above, particular courses can have particular coin values and/or quantities; therefore, the quantity and value of such coin is based on the course characteristics and/or identity (e.g., a prestige of the course).

Thus, based on the Step 408's issuance of cryptocurrency to the user for playing the course, engine 300 can store the issued cryptocurrency in a digital wallet of the user, as in Step 410. In some embodiments, the digital wallet can be a proprietary digital wallet managed by the user, by a third party, by the course, and/or by engine 300, or some combination thereof.

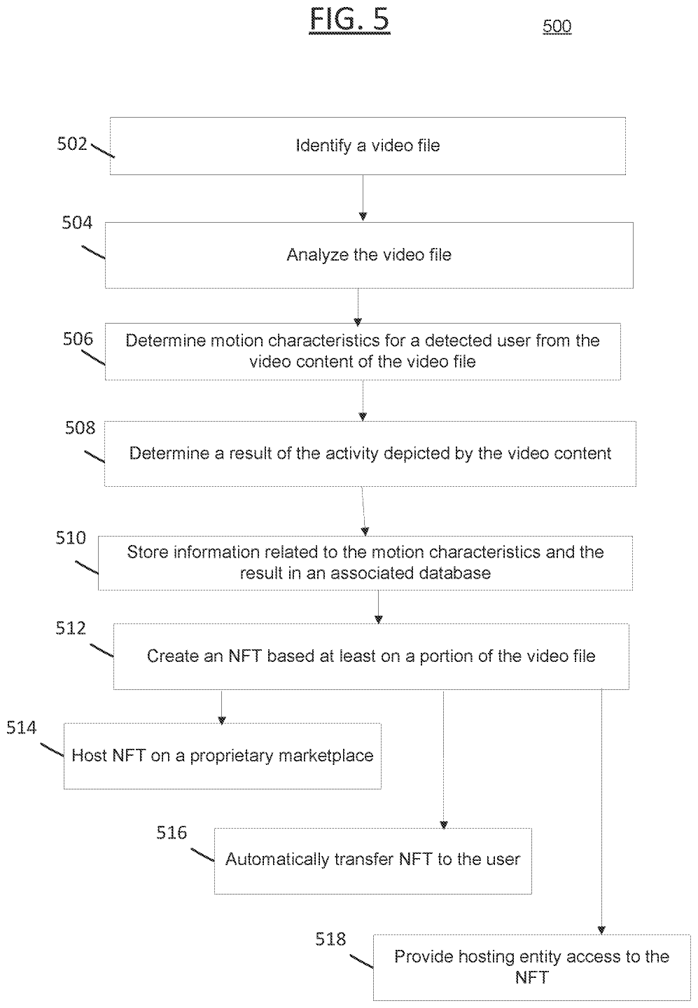

In Step 412, engine 300 is configured to monitor activities of the user as he/she plays the course. This enables the automatic determination of whether the criteria included in the smart contract for the user is satisfied, whereby subsequent actions can be performed (e.g., issue additional cryptocurrencies and/or allocate specific NFTs, as discussed below in at least FIGS. 5 and 6).

Turning to FIG. 5, Process 500 details non-limiting example embodiments for engine 300 utilizing on-site video recording capabilities that enables users to have their activities recorded (or captured) for the purposes of determining whether they are to be rewarded with a digital asset(s).

It should be understood that while the discussion herein will focus on a single video file for a user, it should not be construed as limiting, as the processing described herein can be performed a plurality of video files for a plurality of users (as well as other forms of content that have multi-media portions) without departing from the scope of the instant disclosure.

According to some embodiments, Steps 502-510 of Process 500 can be performed by video module 302 of digital asset engine 300; and Steps 512-518 can be performed by NFT module 306.

Process 500 begins with Step 502 where engine 300 identifies a video of a user. As discussed above, for example, the video is a user's tee-shot on a hole-for example, a tee-shot on a par-3 hole that is assigned to a closest to the pin competition.

According to some embodiments, the video can be identified as part of a real-time (or near real-time or substantially simultaneous) capture of the video. That is, the video can be a streaming, live recording of the user as he/she hits the tee shot (e.g., as the video is created, or currently being captured as a player plays a particular hole on a golf course, for example). In some embodiments, the video can be identified from a collection of stored videos of user shots, which can be associated with a single user or a plurality of users. In some embodiments, the collection can be for a specific competition at a specific course, and can be identified at the conclusion of the competition.

In some embodiments, the video file can be identified as part of a search. In some embodiments, the video file can be a file that is being streamed, uploaded, downloaded, shared, and the like, or some combination thereof.

In some embodiments, the user's tee-shot can be captured by a set of cameras, as discussed above. For example, there can be cameras on the tee-box and on the green, where the tee-box cameras capture the user's swing, and the green-side cameras capture where the ball lands. In some embodiments, engine 300 can splice these videos together so as to seamlessly capture the user's shot from when contact is made with the ball to where it lands. According to some embodiments, engine 300 can utilize any type of known or to be known video merging algorithm, technology or mechanism. In some embodiments, existing mechanisms owned by the entity operating framework can be utilized, as discussed in more detail below (e.g., in relation to Step 506).

In Step 504, engine 300 can analyze the video file. According to some embodiments, the analysis of Step 504 can involve parsing the video file and identifying the portions that correspond to the “game-play” content (e.g., golf swing, the golf ball's trajectory and where it lands and settles on the golf course), while filtering out background noise or feedback.

According to some embodiments, Step 504 can involve performing computational analysis on the video file. In some embodiments, this can involve engine 300 any type of known or to be known Al or machine learning (ML) algorithm, technique, mechanism or technology, such as, but not limited to, computer vision, Bayesian network analysis, Hidden Markov Models, neural network analysis (e.g., artificial neural networks (ANNs), convolutional neural networks (CNNs), and the like), logical model and/or tree analysis, and the like.

According to some embodiments, as discussed above, the video identification processing and video analysis processing discussed herein can be performed using the computational video analysis disclosed in commonly owned applications: U.S. patent application Ser. No. 17/680,506, entitled “Autonomous Activity Monitoring System and Method,” filed Feb. 25, 2002; and U.S. patent application Ser. No. 17/680,788, entitled “Artificial Intelligence-Enabled Golf Course,” filed Feb. 25, 2022, which are both incorporated in their entirety by reference.

In Step 506, as a result of the analysis performed in Step 504, engine 300 can determine motion (or shot) characteristics for a detected user from the video content of the video file. According to some embodiments, such characteristics can include, but are not limited to, which tees were used by the player, whether the player hit the ball with a right-handed or left-handed swing, ball type, club type, swing speed (e.g., club head speed), swing trajectory, swing angle (e.g., attack angle), ball compression, spin speed, height, angle of decent, ball trajectory, landing spot for ball, and resting spot of ball (e.g., respective to the hole location), and the like, or some combination thereof.

In Step 508, engine 300 can determine a result of the activity captured in the video. According to some embodiments, the determined result can be based on the criteria indicated in the smart contract (from Process 400). For example, for a closest to the pin competition, engine 300 can determine how close the user's tee-shot was to the pin. In some embodiments, such determination can be performed using the AI/ML algorithms discussed above in relation to Step 504. In some embodiments, such determination can be based on a set of factors including, but not limited to, where did the ball land, was it the user's first tee-shot, and the like. For example, if the user's shot was the initial tee-shot (e.g., not a mulligan) and it landed on the green, then engine 300 determine that the calculate distance to the hole (or pin) is valid for purposes of the competition.

In Step 510, the determined characteristics of the user's shot (from Step 506), in addition to the determined result (from Step 508), can be stored in an associated database. In some embodiments, the characteristics can be stored in association with the identified video and an identifier of the user. In some embodiments, the stored data set can be a created data structure that is stored with an identifier pointing to the stored smart contract.

In 512, engine 300 can create an NFT based at least on a portion of the video file. As one of skill in the art would understand, the NFT can be a NFT file, NFT image, NFT segment, NFT video, and the like, which may be used interchangeably in the instant disclosure. According to some embodiments, the NFT can correspond to the entirety of the identified video. In some embodiments, engine 300 can parse the video, identify the portions that correspond to the tee-shot (e.g., removing the practice swings and extra footage after the ball lands), and extract out the portions of the shot and its landing that correspond to the tee-shot. As such, in some embodiments, the NFT can be based on the identified/extracted video portions.

According to some embodiments, the creation of the NFT can be performed according to any type of known or to be known mechanism for creating and ensuring the integrity of the NFT. For example, engine 300 can mine the collection of videos to ensure that only one video corresponds to particular activity/footage, and thereby validate the uniqueness of the content depicted in the NFT video file. In some embodiments, the created NFT can be securely stored in a digital wallet that can be associated with engine 300, a course, a third party, and the like, or some combination thereof.

According to some embodiments, upon the creation of the NFT in Step 512, Process 500 can proceed to Steps 514, 516 and/or 518.

In some embodiments, Step 514 can be performed where the NFT can be hosted by a proprietary marketplace where users can bid on and purchase the NFT. In some embodiments, as mentioned above, the marketplace can be proprietary to engine 300 or the course, or can be a third party NFT marketplace that operates in conjunction with operations of engine 300. In some embodiments, the marketplace can be associated with, but not limited to, a type of player (e.g., range of player handicap), specific holes, courses, regions, time periods, classes, and the like, or some combination thereof.

In some embodiments, Step 516 can be performed wherein engine 300 automatically transfers the NFT video file to the user. In some embodiments, such transfer can correspond to the NFT file being stored in a digital wallet of the user. In some embodiments, the transfer can be effectuated based on a determination that the user places within a winning position of the competition (e.g., top 3 places), as discussed in more detail below in relation to FIG. 6. In some embodiments, the user's smart contract can include a clause that causes engine 300 to automatically debit an amount of cryptocurrency from a digital wallet of the user upon the user playing the closest to the pin hole on the course.

In some embodiments, Step 518 can be performed where the NFT video file can be provided to the hosting entity. In some embodiments, this can correspond to the course and/or the entity associated with execution of engine 300. In some embodiments, Step 518 can involve storing the NFT file in a digital wallet of such parties, whereby it can be uploaded at a later time to a marketplace (as in Step 514). In some embodiments, Step 518 can involve such party sharing or uploading content related to the NFT video file on a website, portal page or social media page/account for access/viewership by other users on the Internet.

Turning to FIG. 6, Process 600 details non-limiting example embodiments for determining a winner or ranking of users for a competition taking place at a venue in relation to an event. For example, as discussed herein, the competition is a closest to the pin competition at a golf course for users (or players) playing on a specific day (e.g., for a scramble, for example). In some embodiments, the competition can be restricted to users playing a course; and in some embodiments, the competition can be restricted to users that have played the course (e.g., have an issued cryptocurrency for that course, or a similar “valued” course. In some embodiments, as discussed herein, the competition can include “off-site” users that are not currently playing the course, but are participating (e.g., wagering/betting on which golfers/players will win the competition). In some embodiments, such off-site users can be included in the competition based on their possession and wagering of a specific type of cryptocurrency (e.g., a coin for the course or a similar value coin-for example, a coin for Pebble Beach can be used for a coin for Augusta National).

According to some embodiments, Steps 602-610 of Process 600 can be performed by output module 308 of digital asset engine 300; and Step 612 can be performed by crypto module 304.

Process 600 begins with Step 602 where a type of competition is identified. In some embodiments, this information can be provided to engine 300 via a hosting entity of the course upon which the competition will be played. In some embodiments, engine 300 can scrape the website of the course (or third party) and determine a type of competition. In some embodiments, logistics of camera positions, number of cameras, locations of cameras (e.g., which holes), types of cameras and to-be-captured footage (e.g., 4K, for example) can be provided to engine 300 as part of the competition identification process of Step 602. In some embodiments, as discussed above, the type of competition can be identified as part of an off-site user registering as a wagering participant in the competition. In some embodiments, such user can access a landing page provided by engine 300, whereby the user can securely wager the proper coin as an entry for the competition.

By way of a non-limiting example, the competition can be a closest to the pin competition. In another example, the competition can be a long drive competition on a par-4 hole. In another example, the competition can be the lowest round from a specific set of tees. In yet another example, as mentioned above, the competition (or sub-competition) can be a fastest swing speed on the tee-shot on the first par-5. Therefore, for example, a playing user can enter the competition to actively participate in the competition, and in another example, an off-site non-playing user can wager on which user they think will win (or place) in the competition (or other types of known or to be known wagers (e.g., top 3 players, winning distance from the pin, and the like)). In some embodiments, a user can be both a participating user and an “off-site” user in that they can participate, yet place bets on other users, including themselves.

While the discussion herein will focus on a single competition for a course for a single day of play, it should not be construed as limiting, as any number of competitions for any number of days of play for any number of courses can be utilized without departing from the scope of the instant disclosure.

In Step 604, criteria is determined that corresponds to the competition, and a set of users are identified. That is, the competition indicates a type of criteria (e.g., closest to the pin—how far from the hole on a specific par-3 hole is a user's tee-shot destination). Engine 300 can utilize this information to search the stored shot characteristics (e.g., from Step 510 of FIG. 5, supra). Thus, in Step 604, engine 300 can identify a set of users shot characteristics data that corresponds to the competition. For example, identify each user's calculated/measured distance to the hole.

In some embodiments, Step 604 can involve identifying only a set of n users (e.g., the top 10 users). In some embodiments, Step 604 can involve engine 300 only identifying users with shot characteristics (e.g., distances) within a predetermined range (e.g., only those users whose shots are within 10 feet of the hole).

In Step 606, the stored information for each user identified in Step 606 is identified. This comparison is utilized to determine a ranking of each user, as in Step 608. That is, engine 300 can rank which users shots are closest to the pin, where the higher a user is ranked, the closer their tee-shot was to the pin. In some embodiments, such comparison and ranking can be performed using the AI/ML algorithms discussed above in relation to Step 504.

In Step 610, engine 300 can select at least one user as a winner of the completion. In some embodiments, the winner can be the highest ranked users. In some embodiments, as discussed above, a top n (e.g., top 3) set of users can be selected.

In Step 612, engine 300 can identify a digital wallet of the selected user(s), and automatically deposit a specific type and value of cryptocurrency in the respectively identified digital wallet(s). According to some embodiments, the value, quantity and type of cryptocurrency can be based on indicators associated with the competition, the course and/or the framework. According to some embodiments, special coins can be created for each competition, and can have a value delegated according to the place a user finishes in a competition. In some embodiments, the coins issued as a result of the competition can be a same type of coin issued when a user beings play of a round (as discussed above in relation to FIG. 4).

In some embodiments, the disclosed framework (e.g., engine 300) can be configured to take a percentage of each winning/issued coin, and have that value deposited in a digital wallet associated with the framework, as discussed above.

In some embodiments, users can request to be paid out in specific forms of currency, which can be, but are not limited to, alternate types of cryptocurrency or fiats. In some embodiments, payment can be provided via a user's account on payment service/platform/application (e.g., Venmo™, for example). As such, Step 612 can involve engine 300 converting the winning coins to a requested form, and transferring that formatted value to the digital wallet of the winning user(s).

According to some embodiments, in line with the discussion related to FIGS. 4-6 discussed above, a user (e.g., player of a golf course) can be provided a specific type and/or value of a coin. According to some embodiments, engine 300 can mine and be solely responsible for generating and controlling the novel coin(s) based on the user playing the course and/or entering a competition, as discussed above. In some embodiments, coins for specific courses can be used interchangeably with other courses of a similar class. For example, a coin for a famous, world class course, such as Pebble Beach, can be used for events at St. Andrews. Similarly, coins for local public courses can be used for other local municipal courses. Such interchange, as discussed above, can be utilized for entering competitions as a player or an “off-site” user, as discussed above.

In some embodiments, the payout of a participating user can be weighted differently than an off-site user. For example, a user that enters a competition by wagering a value of cryptocurrency can be paid out more for winning (or playing in a specific position) than another user that is simply an observing, betting user.

FIG. 7 is a work flow process 700 for serving or providing related digital media content based on the information associated with a video file, an issued coin and/or an obtained NFT, as discussed above in relation to at least FIGS. 4-6. In some embodiments, the provided content can be associated with or comprising advertisements (e.g., digital advertisement content). Such information can be referred to as “digital asset information” for reference purposes only.

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In Step 702, digital asset information is identified. This information can be derived, determined, based on or otherwise identified from the steps of Processes 400-600, as discussed above in relation to FIGS. 4-6.

For purposes of this disclosure, Process 700 will refer to single digital asset (and/or corresponding video file information); however, it should not be construed as limiting, as any number of digital assets, for any number of video files, for any number of users, for any number of golf courses and/or competitions, can form such basis, without departing from the scope of the present disclosure.

In Step 704, a context is determined based on the identified digital asset information. This context forms a basis for serving content related to the digital asset information. For example, the context can be determined based on a topic or topic(s) derived from a video for which a coin was issued and/or NFT obtained. For example, if a player is detected as using Callaway® golf clubs, then the context in Step 704 can be identified as “Callaway”.

In some embodiments, the identification of the context from Step 704 can occur before, during and/or after the analysis detailed above with respect to Processes 400-600, or it can be a separate process altogether, or some combination thereof.

In Step 706, the determined context is communicated (or shared) with a content providing platform comprising a server and database (e.g., content server 106 and content database 107, and/or advertisement server 130 and ad database). Upon receipt of the context, the server performs (e.g., is caused to perform as per instructions received from the device executing the engine 300) a search for a relevant digital content within the associated database. The search for the content is based at least on the identified context.

In Step 708, the server searches the database for a digital content item(s) that matches the identified context. In Step 710, a content item is selected (or retrieved) based on the results of Step 708.

In some embodiments, the selected content item can be modified to conform to attributes or capabilities of a device, browser user interface (UI), page, interface, platform, application, exchange, marketplace or method upon which a user session will be initiated, continued and/or retained, and/or to the application and/or device for which a video (or NFT) is being displayed and/or rendered and/or a coin is being hosted. In some embodiments, the selected content item is shared or communicated via the application or browser the user is utilizing to consume the video file. Step 712.

In some embodiments, the selected content item is sent directly to a user computing device for display on a device and/or within the UI displayed on the device's display (e.g., within the browser window and/or within an inbox of the high-security property). In some embodiments, the selected content item is displayed within a portion of the interface or within an overlaying or pop-up interface associated with a rendering interface displayed on the device.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “player”, “subscriber” “consumer” or “customer” should be understood to refer to a user of an application or applications as described herein and/or a consumer of data supplied by a data provider. By way of example, and not limitation, the term “user” or “player” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, a user participating in play at a venue, the play of the user corresponds to a competition involving at least a portion of the venue;
allocating, by the device, a value of cryptocurrency to a digital wallet of the user;
creating, by the device, a smart contract for the user and the venue, the smart contract corresponding at least to the competition;
identifying, by the device, a video file associated with the play of the user, the video file comprising digital content recorded in connection with at least the portion of the venue;
analyzing, by the device, the video file, and determining, based on the analysis, motion characteristics of the user;
determining, by the device, a result of the user's play in connection with the competition based on the motion characteristics;
determining, by the device, a ranking of a set of users that includes the user based on each user's motions characteristics;
identifying, by the device, a winning user of the competition based on the ranking; and
automatically, by the device, without user input, issuing a set of cryptocurrency to a digital wallet of the winning user.

2. The method of claim 1, further comprising:
creating, based on the identified video file, a NFT file.

3. The method of claim 2, further comprising:
automatically transmitting the NFT file to the digital wallet of the user when the user is the winning user.

4. The method of claim 2, further comprising:
hosting, over a network, the created NFT file on a NFT marketplace.

5. The method of claim 1, further comprising:
converting the set of cryptocurrency to an alternative format, wherein the issuance by the device comprises storing the alternative format in the digital wallet of the user.

5. The method of claim 1, wherein the venue is a golf course.

6. The method of claim 5, wherein the portion of the venue corresponds to at least one hole of the golf course.

7. The method of claim 1, wherein the value of the cryptocurrency allocated to the digital wallet of the user is based on an identity of the venue.

8. A non-transitory computer-readable storage medium tangibly encoded with computer-executable instructions, that when executed by a processor associated with a device, performs a method comprising:
identifying, by the device, a user participating in play at a venue, the play of the user corresponds to a competition involving at least a portion of the venue;
allocating, by the device, a value of cryptocurrency to a digital wallet of the user;
creating, by the device, a smart contract for the user and the venue, the smart contract corresponding at least to the competition;
identifying, by the device, a video file associated with the play of the user, the video file comprising digital content recorded in connection with at least the portion of the venue;
analyzing, by the device, the video file, and determining, based on the analysis, motion characteristics of the user;
determining, by the device, a result of the user's play in connection with the competition based on the motion characteristics;
determining, by the device, a ranking of a set of users that includes the user based on each user's motions characteristics;
identifying, by the device, a winning user of the competition based on the ranking; and
automatically, by the device, without user input, issuing a set of cryptocurrency to a digital wallet of the winning user.

9. The non-transitory computer-readable storage medium of claim 8, wherein the method further comprises:
creating, based on the identified video file, a NFT file.

10. The non-transitory computer-readable storage medium of claim 9, wherein the method further comprises:
automatically transmitting the NFT file to the digital wallet of the user when the user is the winning user.

11. The non-transitory computer-readable storage medium of claim 9, wherein the method further comprises:
hosting, over a network, the created NFT file on a NFT marketplace.

12. The non-transitory computer-readable storage medium of claim 8, wherein the method further comprises:
converting the set of cryptocurrency to an alternative format, wherein the issuance by the device comprises storing the alternative format in the digital wallet of the user.

13. A device comprising:
a processor configured to:
identify a user participating in play at a venue, the play of the user corresponds to a competition involving at least a portion of the venue;
allocating, by the device, a value of cryptocurrency to a digital wallet of the user;
creating, by the device, a smart contract for the user and the venue, the smart contract corresponding at least to the competition;
identify a video file associated with the play of the user, the video file comprising digital content recorded in connection with at least the portion of the venue;
analyze the video file, and determine, based on the analysis, motion characteristics of the user;
determine a result of the user's play in connection with the competition based on the motion characteristics;
determine a ranking of a set of users that includes the user based on each user's motions characteristics;
identify a winning user of the competition based on the ranking; and
automatically, without user input, issue a set of cryptocurrency to a digital wallet of the winning user.

14. The device of claim 13, wherein the processor is further configured to:
create, based on the identified video file, a NFT file.

15. The device of claim 14, wherein the processor is further configured to:
automatically transmit the NFT file to the digital wallet of the user when the user is the winning user.

16. The device of claim 14, wherein the processor is further configured to:
host, over a network, the created NFT file on a NFT marketplace.

17. The device of claim 13, wherein the processor is further configured to:
convert the set of cryptocurrency to an alternative format, wherein the issuance by the device comprises storing the alternative format in the digital wallet of the user.

18. The device of claim 13, wherein the venue is a golf course.

19. The device of claim 18, wherein the portion of the venue corresponds to at least one hole of the golf course.

20. The device of claim 13, wherein the value of the cryptocurrency allocated to the digital wallet of the user is based on an identity of the venue.
